(19) United States
(12) Patent Application Publication
(10) Pub. No.: US 2009/0321433 A1
(43) Pub. Date: Dec. 31, 2009

(54) Protective electrical box cover

(76) Inventors: Brian Colligan, Budd Lake, NJ (US); Patrick D. Colligan, Long Valley, NJ (US)

Correspondence Address: GEARHART LAW, LLC, 4 FERNDALE ROAD, CHATHAM, NJ, 07928, US

(21) Appl. No.: 12/456,446

(22) Filed: Jun. 17, 2009

Related U.S. Application Data
(60) Provisional application No. 61/073,417, filed on Jun. 18, 2008.

(51) Int. Cl. H01H 9/02; B65D 25/34; B23P 11/00

(52) U.S. Cl. 220/3.2; 220/694; 29/428

(57) ABSTRACT

A protective cover for electrical and communication boxes, which prevents the box from being covered by paneling. The cover is substantially in shape of a protrusion, extending outward ¾ of an inch past the outer lip of the box. The said cover is strongly but removably attached to said box with fasteners that enter the cover through recessed holes in said cover and get attached within the box by using generic holes that are ordinarily used for attaching hardware normally present in such said box.

### CLAIM OF PRIORITY

This application claims priority to U.S. Ser. No. 61/073,417 filed Jun. 18, 2008, the contents of which are fully incorporated herein by reference.

### FIELD OF THE INVENTION

The present invention generally relates to protective covers for openings, and more particularly to protective covers with protrusions that attach to electrical/communication boxes.

### BACKGROUND OF THE INVENTION

The present invention relates to a cover designed to prevent an electrical or communication box from being covered over and concealed during the paneling stage of room construction.

Typically, the interior rooms of a structure are completed in a series of steps that build on each other. First, a framer frames the skeleton of a room with studs. In residential construction a stud is usually a wooden or hollow metal beam. A room is framed by running horizontal studs opposite each other along the ceiling or overhead beams and the floor, and then joining them with upright studs.

Once the framing is done, an electrician comes in and attaches electrical and communication receptacle boxes to the upright studs. Overhead electrical fixture receptacle boxes are attached to the ceiling beams. A typical electrical box will come in various shapes depending on what it will be used for. In general, a box has four walls joined by a back wall. Opposite the back wall is the open side of the box, which usually faces toward the interior of the room. Wires enter the box through small holes, or punch-outs, in the side walls or the back wall.

The next step is to install insulation, if necessary, between the upright studs and between the overhead beams. The beams and the studs are then covered with paneling. The most common panel is drywall, but can also be pressed or natural wood, wood planks, as well as plastic, vinyl or metal sheets.

One of the challenges facing an electrician is that electrical and communication boxes that are attached to the studs tend to get covered-over and hidden during the paneling stage. This frequently happens due to fast pace of work by a typical paneling contractor. To combat the problem, electricians install-said boxes so that an outer rim or lip of the open side juts out approximately ¼ of an inch past the edge of the stud. For thick drywall or other types of shatter-resistant paneling this may not be enough to prevent incidental or deliberate concealment.

The present invention adds at least an additional three quarters of an inch by which a box will protrude past the outer edge of a stud. This distance makes attaching paneling over the box difficult or impossible since the most common means of attaching paneling to studs is by using 1⅜ to 1¾ inch long screws or fasteners, which at said distance lack proper length to establish a firm grip on the stud. Also, stretching a panel over an obstacle of this width will likely cause it to crack, deform or buckle.

Some devices for covering outlet boxes have been proposed. However, these devices suffer from a number of disadvantages. For example, U.S. Pat. No. 6,867,369 to Wiggins discloses a protective cover with a side wall, a base, and a flange that are of a size and shape to friction fit the recessed base within an electrical box. The main purpose of this cover is to protect the wiring in the box from building debris. The cover is substantially flat with the outer rim of said box. Therefore protection against paneling over the box will not be achieved.

U.S. Pat. No. 6,687,370 to Compagnone Jr., discloses a cover which either frictionally inserted into an electrical box, or is held in place on top of the box with several wings that expand outwardly inside the box in a spring-load manner. A handle for inserting and removing protrudes from the outer surface of the cover. However, the disclosed cover is still substantially flat and the handle is not wide enough to prevent undesired covering over.

U.S. Pat. No. 4,907,711 to Stuchlik discloses a substantially planer cover containing a plurality of legs at the lateral edges of the cover that are inserted into an electrical box. Jagged protrusions extend above the cover, opposite the legs. The protrusions can be used to mark the cut-out location for the box on the drywall, or can be used to pierce the drywall that is installed over the box, to keep the box location clearly marked. The invention is intended to only be used with drywall and can cause undesirable damage to other kinds of paneling. The pointy protrusions contain sharp edges that pose undesirable risks of injury or property damage. Since this cover is loosely inserted into a box, it can be easily removed by a hasty, sloppy, impatient installer, defeating the purpose of the invention. Finally, this invention teaches away from the concept of preventing a box from being covered by providing means to keep the box location marked if paneling-over occurs, and by providing means to help a drywall installer cut out outlet openings in the drywall. This prior art serves drywall installers more than it serves electricians who are the intended users.

One embodiment of this invention is illustrated in the accompanying drawings and will be described in more detail herein below.

### SUMMARY OF THE INVENTION

The present invention is related to an article of manufacture, in particular to an electrical box cover, having four sides, a back, and an outer lip, that is capable of attaching to an electrical or a communication box; and a protrusion disposed on the cover. The protrusion extends at least ¾ of an inch past the outer lip at a point external to the box.

It is an object of the present invention to provide a new and useful way to prevent an electrical or a communication box from being covered or concealed during the paneling stage of construction. The outward width or depth of the cover and the protruding cap preferably adds ¾ of an inch of distance beyond the outer rim or lip of an electric box, which is already protruding ¼ of an inch past the outer edge of a stud. The overall distance makes it nearly impossible to attach a panel over the box with commonly used fastening means.

Another object of the present invention is to ensure that the covers of do not get inadvertently or deliberately removed. The cover is attached by multiple screws, or alternatively, with spring loaded clips that either clip unto the outer lip 90 or expand within the box 75 and frictionally abut the walls 80. Another alternative embodiment would be to mount the cover 5 unto the box 75 with snap-on mechanism, that includes snaps and latches or just snaps (not shown). In the embodiment using snaps and latches, it is preferable that the latches are disposed on the box 75 and are formed into slight tabs, so that no significant modification is needed to remove the cover 5 before final installation of the electrical box components. A paneling installer is induced to cut out box openings in the paneling prior to installation, since it will be just as difficult and time consuming to remove covers from the electrical boxes. This is in contrast to prior art covers which are easily removed.

Yet another object of the present invention is to provide a preferred embodiment of the present invention that completely covers an opening of a box. This embodiment keeps debris out of the box besides providing all aforementioned benefits.

Another object of the present invention is to provide a safe, aesthetically attractive, way to prevent an electrical or a communication box from being covered during the paneling stage of construction to protect wires from paint, spackle and rotozip damage. Safety is enhanced by the cap not containing any sharp edges. The clean flowing lines of protruding cap, create a noticeable polished look to an electric receptacle installation.

### BRIEF DESCRIPTION OF THE DRAWINGS

FIG. 1 is a front perspective view of a protective cover of the present invention prior to being fastened to the opening of an electrical box.

FIG. 2 is a front view of the cover.

FIG. 3 is a side view of the cover. The cover illustrated is shaped as a parallelogram. This view shows the side view along the long side of the parallelogram.

FIG. 4 is top view of the cover, along the short side of the parallelogram. This view shows the position of the cover fasteners and the outward bow of the extending flaps.

FIG. 5 is a front perspective view of a protective cover prior to being fitted on to an electric box.

FIG. 6 is a side view of the invention as it is intended to be used in practice. The cover is attached to the box, which is mounted on a stud. The cover appears to block a section of sheetrock from attaching to the stud.

FIG. 7 is a side view of a first alternative embodiment of the cover, illustrating a square shaped cap part of the cover.

FIG. 8 is a side view of a second alternative embodiment of the cover, showing the cap part of the cover to be in a form of longitudinal ribs of equal height.

FIG. 9 is a side view of a third alternative embodiment of the cover, showing the cap part of the cover to be substantially cone shaped.

FIG. 10 is a side view of a fourth alternative embodiment of the cover, showing the cap part of the cover to be an inwardly facing arch.

### DESCRIPTION OF THE PREFERRED EMBODIMENTS

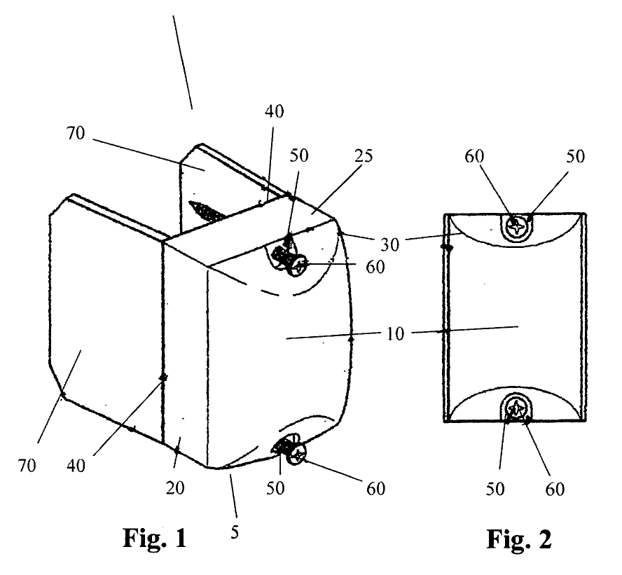

The preferred embodiments of the present invention will now be described with reference to FIGS. 1-10 of the drawings. Identical elements in the various figures are identified with the same reference numerals.

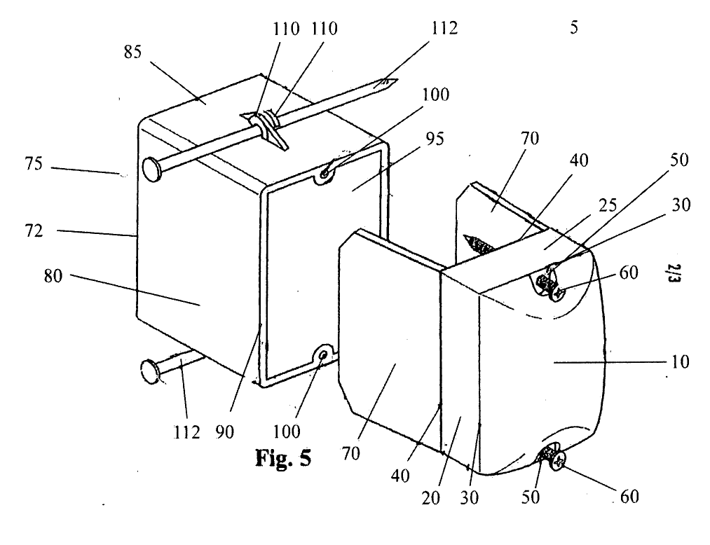

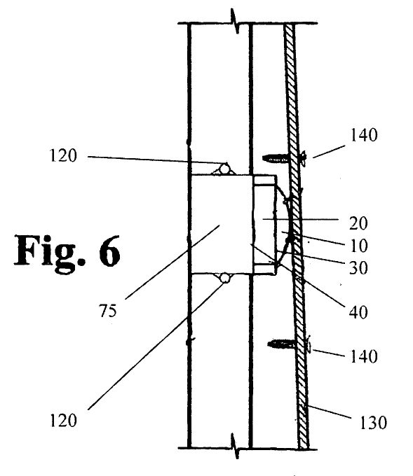

Referring to FIG. 1, the present invention is directed to a temporary protective cover 5 for an electrical/communications box (shown in FIG. 5). As illustrated, the cover 5 is comprised of the cap 10, which preferably contains recessed fastening holes 50 for fasteners 60. The fasteners are intended to securely attach the cover 5 to the box 75 (FIG. 5). The cap 10 is linked to the wall 20 by the outer edge 30. The wall 20 can take the shape of a parallelogram, as illustrated, where opposite walls 20 are joined by opposite shorter walls 25. Alternatively, the wall 20 can be a single round surface. This wall separates, and is located between, the outer edge 30 and the inside edge 40. The width of the cover between the inside edge 40 and the outermost point of the cap 10 is preferably at least ¾ of an inch and 2 inches. It is important to note that the cap 10 forms various shapes that constitute a protrusion, and that the cap 10 is integral with the cover 5. The wall 20 and the cap 10 are mounted to and protrude from the outer lip 90 of the box 75 (FIG. 5). Emanating from opposite sides of the inside edge 40 are optional flap walls 70. The two flap walls 70 oppose each other and bow away from each other. These flap walls 70 are intended to fit within an opening of a box covered by said cover 5.

In one embodiment of the invention, the walls 20 are sized to match outer lip 90 of box 75. Thus, edge 40 will mate with outer lip 90. In this case, the cover 5 can simply be screwed onto box 75.

In another embodiment, flaps 70 can have a minimum length and can be sized to fit inside box 75. Like the embodiment described immediately above, edge 40 will rest on lip 90, with flaps 70 being slightly offset so that flap 70 forms an internal lip that prevents movement of cover 5.

In another embodiment, flap walls 70 extend the entire length of box 75 and abut the bottom surface 72. In this manner, the flap walls 70 further support the cover 5 against the force of a segment of paneling that is pressed against it.

While the figures show the cover 5 using fasteners 60 to attach the cover 5 to the box 75, it is also possible that cover 5 may be secured to box 75 where flaps 70 have flanges that can fit into box 75. Thus, when cover 5 is inserted into the box 75, the flanges on flap walls 70 interlock with box 75, thus securing the cover 5 to the box 75. The box 75 could have perforations that allow the cover 5 to be detached from the flaps 70 or flanges to remove the cover 75 from the box after the wall board is installed, or prior to installing the internal component of an electrical or communications box 75.

Also, while fasteners 60 are shown in the dry wall are typical machine head screws, the screws can have any head configuration known in the art, such as square head, hex head, or Philips head configurations. It is also possible that fasteners 60 are a proprietary fastener requiring a proprietary tool to remove the screw. This type of system will make it even more difficult for workers to remove an installed cover 5 prior to paneling.

FIG. 2 is a front view of the cap 10. The fasteners 60 fit snugly within the recessed fastening holes 50. The head of the fastener 60 is entirely contained within the area of the cap 10 and does not protrude sideways beyond the area of the cover 5. The fastener 60 is located at the outer edges of the cap 10 and runs the entire width of the cap 10 and the wall 20 and into a box to be covered. The location of the fastening holes 50, is generally conforming to the location of the cover-facing fastening holes 100 (FIG. 5), found in a universal electric/communication box. Cover 5 uses the same attachment holes within the box as are normally used to mount an outlet or a switch within the box. No specialized fastening holes need to exist in the box 75 to attach the cover 5. In addition, the cover may fit over an outlet or switch that is already wired and installed on cover facing fastening holes 100.

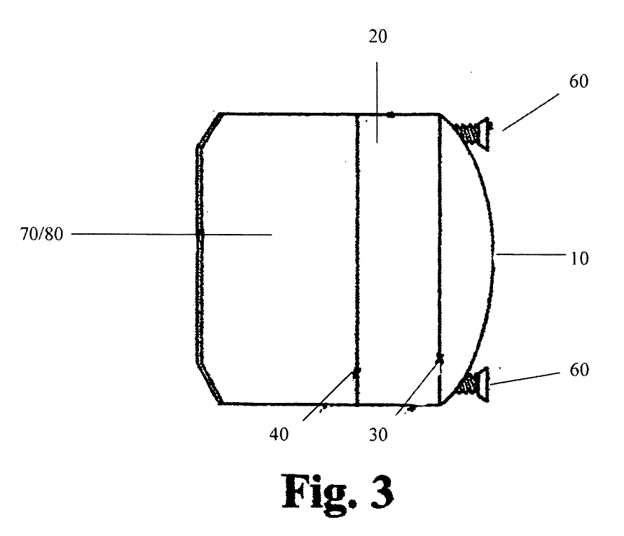

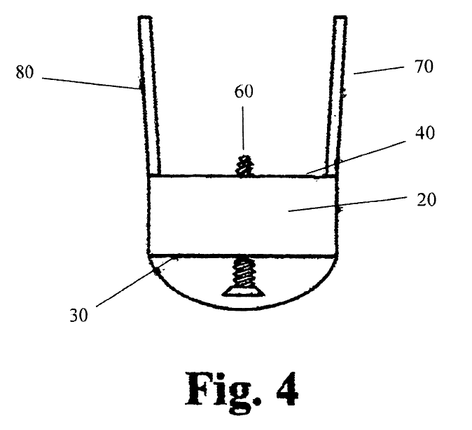

FIG. 3 and FIG. 4 show a side view of the cover. FIG. 3 shows that the flap wall 70 is not wider than the inside edge 40 from which it emanates. As suggested by FIG. 4, the opposing flaps 70 are bowed away from each other.

FIG. 5 illustrates how the cover 5 of FIG. 1 is mounted on a standard electrical/communications box 75. A conventional box 75 (rectangular box illustrated) includes a pair of opposite side walls 80, and opposite shorter sidewalls 85, which define an opening 95 into the box 75. Alternatively, box 75 may be round or have other shapes common to the industry. The cover 5 is attached to the box 75 with fasteners 60, which run through the recessed fastening holes 50 and into the fastening holes 100 of the box 75. The cover-facing holes 100 of the box 75 are located on the outer lip 90 of the box, but can be located anywhere else as dictated by the field of art using a given box 75 (not illustrated). The box 75 is attached to a wall stud with fasteners 120 which are threaded trough the fastening loops 110. The fastening loops 110 are located on the opposite ends of the box 75, outside the opening 95.

It is important to note that the total distance the protrusion extends past the surface of the stud is at least 1 inch. Most electrical boxes have a setting tab disposed on the side of the box that meets the stud. The setting tab is typically at least ¼ inch behind the edge of the box, creating at least a ¼ inch “reveal”. Thus, the total distance from the stud to the end of the protrusion is the sum of ¼ inch, the distance of the offset, and the length of the protrusion, is preferably at least ¾ of an inch, so the total protruding distance is at least 1¼ inches.

The cover unit 5 is sized to cover the opening 95 of the box 75. However, since the main purpose of the cover 5 is to prevent the box 75 from being covered over during sheeting or paneling, it does not matter to the invention how much of the opening 95 is actually covered. Electrical box 75 may be a single-gang electrical box, such as illustrated in FIG. 5, or a multiple gang box, such as a double gang, four gang, six gang, etc. (not illustrated). The box is typically used to hold a wiring device, such as a duplex receptacle, a toggle switch, a fixture, or communications connectors, such as a phone jack (none illustrated).

FIG. 6 illustrates the main function of the invention. The electrical box 75 is shown fastened to a stud with the cover 5 attached to the front of the box. The wall 20 and the cap 10 form a protruding member of the cover 5 and extend at least ¾ of an inch beyond the outer lip 90 of the box 75 and the stud, as shown. When a sheet of paneling 130 is applied to the stud during the course of sheetrock installation, the sheetrock fasteners 140 are inhibited from reaching and affixing on the stud by the protruding member of the cover 5. This prevents the box 75 from being covered-over during the sheeting stage of construction. It is important to note that while prior art electrical box covers teach means to cover the electrical box, none teach protruding out far enough to severely inhibit the ability of wallboard panels to be attached to a stud. The distance that the cover protrudes from the stud is critical because wallboard paneling is made from flexible materials that can bend easily and therefore can be screwed down over covers that are not of sufficient height. The inventors have determined that a distance of at least three quarters of an inch external to the lip of the box is the minimum necessary to prevent “boarding over” of an electrical box, and this distance can be up to 2 inches or more from the lip of the box.

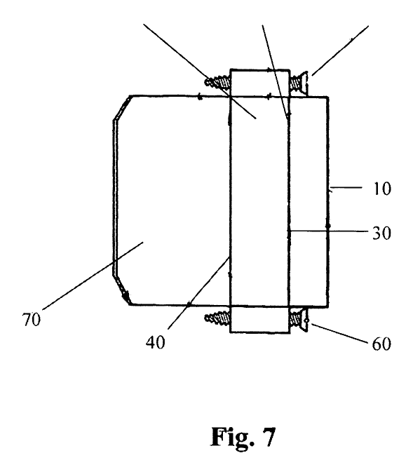

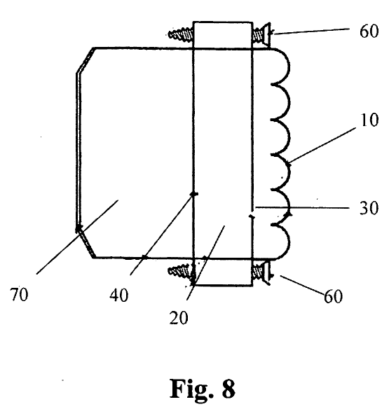

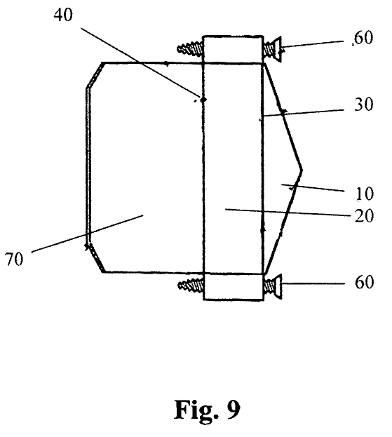

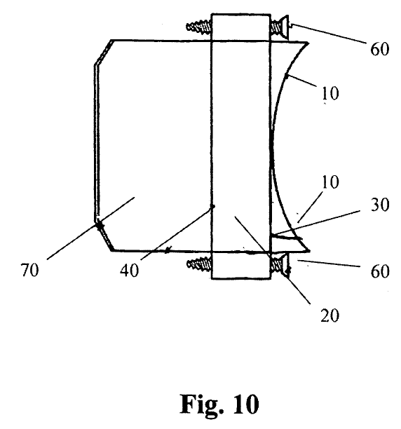

Various alternative embodiments of the present invention are shown in FIGS. 7-10. Four alternative embodiments are illustrated in contrast to the embodiment in FIG. 1. In FIG. 1 the cap 10 was in a shape of an outer facing convex arch. The center of the arch is the farthest point of the cover 5 from the opening of the box 95, with the outlying edges of the cap not extending beyond the outer edge 30. FIG. 7 is distinguished in that the walls 20, 25 (FIG. 1) extend past the outer edge 30, with the cap 10 forming a substantially planar, flat surface that links the opposite walls 20, 25. In FIG. 8, the cap 10 forms longitudinal ribs of equal height. In FIG. 9 the outlying sides of the cap 10 are starting from the outer edge 30 in a straight and outward direction, forming a conical tip at the center of the cap 10. In FIG. 10, the cap forms in inner curving arch, such that the center of the arch is the point closest to the opening 95 of the box 75, with the outlying edges being farthest away from the opening 95.

As stated above, the main purpose of this invention is keep the box 75 free of any concealment during the paneling stage of construction. The distance of the protrusion from the outer lip of the box, the wide surface area of the cap 10 and the fasteners 60 all combine to fulfill this purpose.

Fasteners 60 play a key role in the invention. Firstly, they provide the means by which the cover will remain securely attached to the box while various construction activities are taking place in the vicinity of the box 75. Recessed fastening holes 50 are designed to conform with a set of fastening holes 100 that are normally found in boxes of this type and which otherwise serve as attachment points for ordinary electrical or communication hardware found in such box. This is especially desirable, since the box does not need to contain any specialized mechanism or any extra slots to be able to utilize this cover. An electrician wishing to utilize this invention can continue using generic boxes prevalent in the art and need not incur extra costs associating with obtaining compatible boxes and covers. In addition, the cover need not necessarily be paired up with a specific box. Instead the generic nature of the cover can be preserved by designating it in conformity with a particular field of art or to a function within a particular field of art. The attachment slots on the cover 50 will conform with existing fastening holes 100 on the box 75.

Fasteners 60 also promote the overall purpose of the invention by making it difficult to remove the cover from the box. A typical room will contain a plurality of boxes 75 containing outlets, namely, at least several boxes 75 for light switches, telephone, microphone and computer networking, as well as boxes 75 for light fixtures. When all of these boxes 75 have covers attached to them with fasteners 60 or other secure means of fastening, their removal requires tools, time and effort. Thus a paneling installer is motivated to prepare openings in the paneling for the boxes prior to affixing the paneling to studs and beams, since a similar or greater effort will be required to remove the covers before paneling over the boxes. As an additional precaution, an electrician can employ screws or other fastening means with proprietary heads, requiring a matching tool bit to remove cover.

The protruding cap 10 of this invention is spread across a substantially wide area, encompassing most if not all of the area of the box 75. This area is also at least ¾ of an inch away from the stud. Paneling over either one of these factors is difficult but not impossible. Paneling-over becomes impossible when both factors are combined. The width of the cover will prevent the paneling attachments form gripping a supporting stud (FIG. 6), while the broad area may crack or deform a panel if paneling-over is attempted.

The wide area of the cap 10 presents a polished, professional finish to an electrical box installation, which is highly desirable and also avoids safety problems by presenting a single blunt protrusion that is unlikely to cause injuries or property damage. Additionally, an embodiment of said cover that completely covers the opening of said box provides an added benefit of keeping construction debris out of the box. However, a complete covering is not necessary for the enablement of the present invention. An alternative enabling design can include a cover that is perforationally attached, or attached with a fastener to the bottom 72 or the side 80 of the box 75, or a cover 10 that is in a shape of a cross or any other shape that fulfills the main purpose of the present invention, but which does not necessarily cover the entire cavity of the box 75.

Although this invention has been described with a certain degree of particularity, it is to be understood that the present disclosure has been made only by way of illustration and that numerous changes in the details of construction and arrangement of parts may be resorted to without departing from the spirit and the scope of the invention.

We claim:

1. An article of manufacture comprising:
a box having four sides, a back, and an outer lip;
a cover having a mechanism suitable for attaching a cover to the box; and
a protrusion disposed on the cover, wherein the protrusion extends at least ¾ of an inch past the outer lip at a point external to the box.

2. The article of claim 1, wherein the four sides of the box define an opening and the cover at least partially covers the opening of the box.

3. The article of claim 1, wherein the cover is attached to the outer lip with at least one perforation.

4. The article of claim 1, wherein the cover attaches to the box using spring loaded clips that connect with at least one side of the box.

5. The article of claim 1, wherein the cover is attached to the box using a fastening mechanism that requires a specialized instrument to remove the said cover from the box.

6. The article of claim 1, wherein the protrusion is substantially convex.

7. The article of claim 1, wherein the shape of the protrusion is selected from the group consisting of squared, ached, rippled, pointed and concave.

8. The article of claim 1, wherein the electrical box is selected from the group consisting of a single gang box, a double gang box or a triple gang box.

9. The article of claim 1, wherein the cover is a form of a cross, and the protrusion is disposed thereon.

10. The article of claim 1, wherein the protrusion is a bar which spans the opening of the box.

11. An article of manufacture comprising:
a cover having a protrusion disposed on the cover;
the cover attachable to an electrical box having an outer lip the electrical box further having a reveal of at least ¼ inch; and
wherein the protrusion extends at least ¾ of an inch past the top of lip of the electrical box at a point external to the electrical box.

12. The article of claim 11, wherein the cover is disposed on the electrical box.

13. The article of claim 11, wherein the cover is removable from a box along at least one perforation.

14. The article of claim 11, wherein the cover is affixed to the box with a specialized fastening system.

15. The article of claim 11, wherein the shape of the protrusion is selected from the group consisting of squared, ached, rippled, pointed and concave.

16. An article of manufacture comprising:
a cover for a box, wherein the box has an outer lip, and a protrusion integral with the cover, wherein the protrusion extends at least ¾ of an inch outside the outer lip of the box.

17. The article of claim 16, wherein the cover is mounted on the box using at least one fastener.

18. The article of claim 16, wherein the cover is mounted to the outer lip of a box by using a snap-on mechanism.

19. The article of claim 16, wherein the protrusion is substantially concave shape.

20. A method for preventing obstruction of an electrical box during dry walling and speckling; comprising the steps of:
attaching an electrical box having a protruding member extending at least ¾ of an inch outside the area of the box.
